(19) United States
(12) Patent Application Publication
(10) Pub. No.: US 2016/0245576 A1
(43) Pub. Date: Aug. 25, 2016

(54) Side Accessible Ice Chest

(71) Applicant: Richie L. Harral, Jonesboro, AR (US)

(72) Inventor: Richie L Harral, Jonesboro, AR (US)

(21) Appl. No.: 14/631,170

(22) Filed: Feb. 25, 2015

(51) Int. Cl. F25D 3/06; B62B 1/26

(52) U.S. Cl. CPC F25D 3/06; B62B 1/26; F25D 2400/38

(57) ABSTRACT

An insulated, cryogenic container including side panels having pivot-out top-accessible bins that may be accessed without moving a lid.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of the Invention

The present disclosure relates to a cryogenic shipping and storage container. More particularly, the present disclosure relates to containers known as ice chest or coolers, especially useful for cooling beverages and other items during outdoor activities.

(2) Background of Invention

The prior art includes a wide variety of cooling containers used for storage and transport of beverages and food. Some cooling containers can also be used for transportation and storing medicine related products and devices. Many cooling containers use ice as a cooling component that can be loaded into the chest from the top of the container by replacing the lid. Some ice chests can be carried with handles and might have wheels to make transportation easier. To access the contents of the ice chest, typically the lid must be opened. However, ice chest often double as chairs and tables, especially when used in outdoor recreational activities such as camping and tailgating. In such situations, before the contents of the ice chest can be accessed, it is necessary to clear the lid of whatever is resting upon it. This is often inconvenient.

Known in the art are the following patents and published applications, arguably related to the patentability of the present invention:

| | 1^{st} Named | Date of Patent/ |
|---|---|---|
| U.S. Pat./App. No. | Inventor | Publication |
| U.S. Pat. No. 271,100 | Morin | 1883 Jan. 23 |
| U.S. Pat. No. 3,028,042 | Gottsegen | 1962 Apr. 03 |
| U.S. Pat. No. D200,309 | Sokolis | 1965 Feb. 16 |
| U.S. Pat. No. 3,395,550 | Dungan | 1967 Jan. 26 |
| U.S. Pat. No. D397,585 | Rausch | 1998 Sep. 01 |
| U.S. Pat. No. 6,497.424 | Gartner | 2002 Dec. 24 |
| U.S. Pat. No. 7,310,967 | Aragon | 2007 Dec. 25 |
| U.S. Pat. No. 7,434,410 | Ford | 2008 Oct. 14 |
| U.S. Pat. No. 7,748,235 | Franklin | 2010 Jul. 06 |
| U.S. Pat. No. 8,196,951 | Blackman | 2012 Jun. 12 |
| U.S. Pat. Appl. No 2012-0211499 | Clement | 2012 Aug. 23 |
| U.S. Pat. No. 8,356,723 | Clement | 2013 Jan. 22 |
| U.S. Pat. No. 8,517,211 | Brown | 2013 Aug. 27 |
| U.S. Pat. No. 8,567,211 | Al-Rasheed | 2013 Oct. 29 |
| U.S. Pat. No. 8,613,464 | Blackeman | 2013 Dec. 24 |

U.S. Pat. No. 3,395,550 issued to Dungun discloses a portable box-like compartmental container for outdoor activities suitable for transportation in the trunk of a car. The container includes two compartments that are tightly closable by a lid; there is a main compartment for ice and items to be cooled, and a smaller auxiliary compartment with a separate lid (for drinking water) and a dispensing spigot.

U.S. Pat. No. 7,310,967 issued to Aragon discloses a cryogenic shipping and storage container, with an on-board cooling unit in the form of a bunker for holding solid refrigerant such as dry ice. The container has an upper lid and a side door, which is filled with the refrigerant.

U.S. Pat. No. 7,748,235 issued to Franklin discloses a portable cooling apparatus which includes an ice chest housing with wheels and a handle, having an inner cavity defined by side walls extending upwardly from a floor, and having a lid to close access to the inner cavity. This ice chest also includes a manifold removably positioned on the floor, the manifold having an inlet and an outlet extending through the one or more side walls to outside the ice chest.

U.S. Pat. No. 8,356,723 issued to Clement discloses a portable ice chest having an outer shell. inner shell, and an insulated layer between. The ice chest also includes an open top which is covered with one or two lids that are attached to the forward and rearward side panels respectively.

U.S. Pat. No. 8,567,211 issued to Al-Rasheed discloses a portable ice chest for medical supplies which includes a box-like housing having a side door providing access to three removable vertically-stacked drawers; there is also a beverage compartment behind the drawers. One of the drawers is adapted to receive dry ice. Each of the drawers includes a plurality of openings to allow air circulation to facilitate refrigeration. A fan and solar panel with a rechargeable battery are located in the top of the housing, for circulating air through the drawers and beverage container.

U.S. Pat. No. 8,613,464 issued to Blakeman discloses a personalizable sports themed ice chest having a main housing and a lid pivotally secured to the housing. Also included are wheels and a collapsible pull handle mechanism connected to the housing.

None of these references, standing alone, expressly discloses an ice chest, at least one of the sidewalls comprising an outer panel of an interior bin pivotally connected at its lower edge to the wall a distance above the wall's juncture with the floor panel to allow interior bin to be pivoted out for accessing while the lid remains closed; nor do any of the listed references disclose any similarly configured second interior bin, or both bins having a floor configured to avoid contact between the bins when either or both are pivoted open.

### BRIEF SUMMARY OF THE INVENTION

The invention disclosed herein is essentially a multi-part side accessible container comprising (including or having) a housing for enclosing at least one interior bin, except that the side portion(s) of the housing providing access to the bin(s) includes an access aperture framed by the housing panel, and the outer wall(s) of the bin(s) occupy the access aperture(s) to complete the enclosure. In general, rather than a traditional open-top box having a lid, the present invention adds pivot-out side bins allowing access to the interior contents without having to move the lid. Such pivotal connection ideally occurs a relatively short distance above the wall's juncture with the floor panel to allow pivot-out opening of the interior bin while the lid remains closed, any second interior bin being similarly configured with and pivotally connected to the opposite wall so as to avoid contact between the lower portions of the bins when either or both are pivoted open.

### BRIEF DESCRIPTION OF FIGURES OF THE DRAWINGS

FIG. 1 depicts a perspective view of a representative sample of the ice chest having a hinged lid open and with both side bins open.

FIG. 2 depicts a top elevation view of the ice chest of FIG. 1.

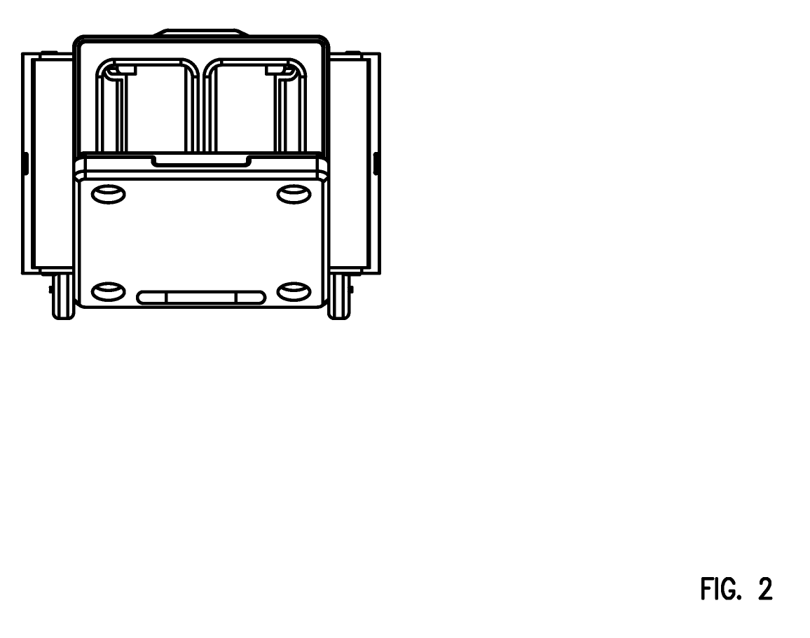

FIG. 3 depicts a bottom elevation view of the ice chest of FIG. 1.

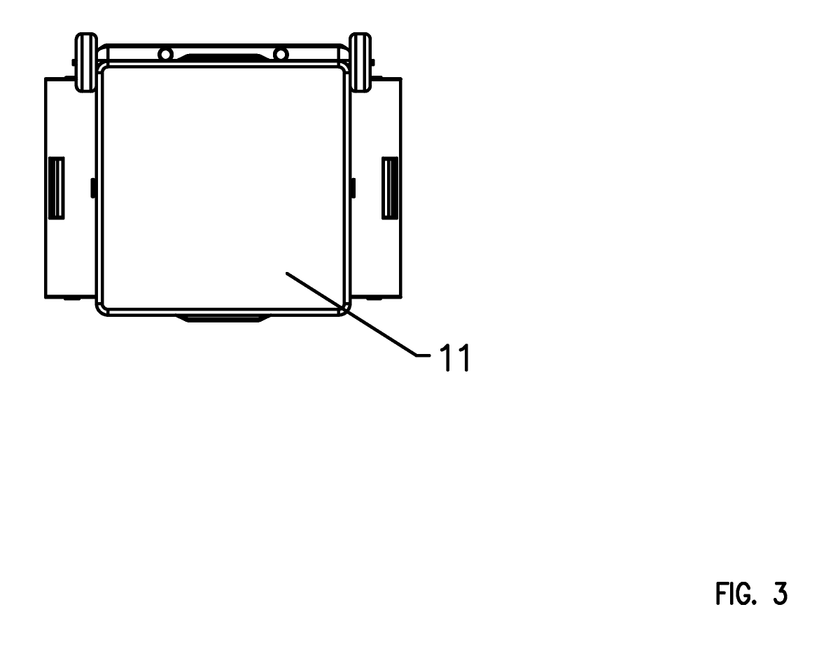

FIG. 4 depicts a left side elevation view of the ice chest of FIG. 1.

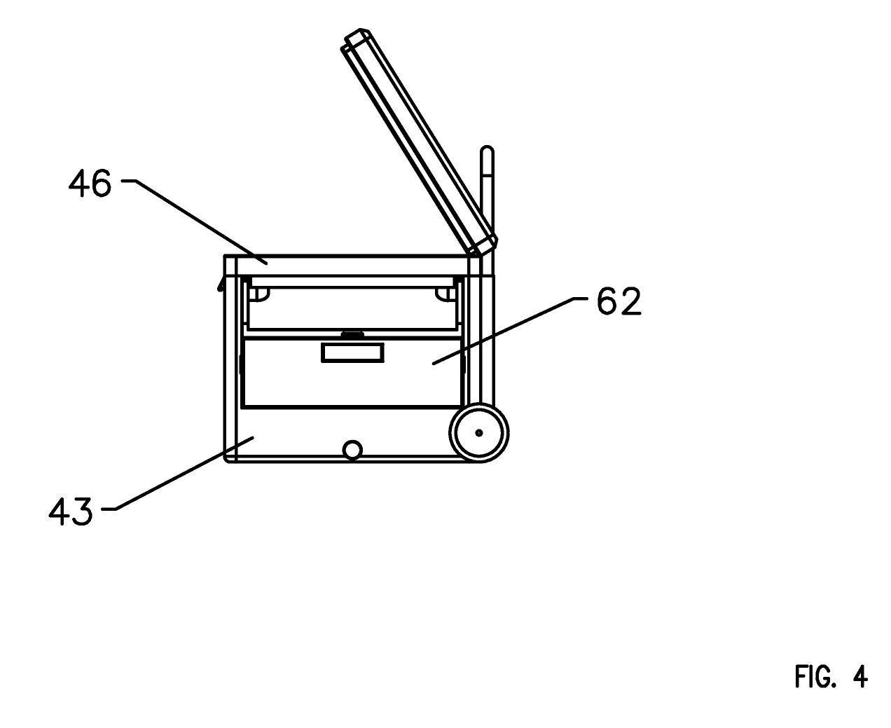

FIG. 5 depicts a right side elevation view of the ice chest of FIG. 1.

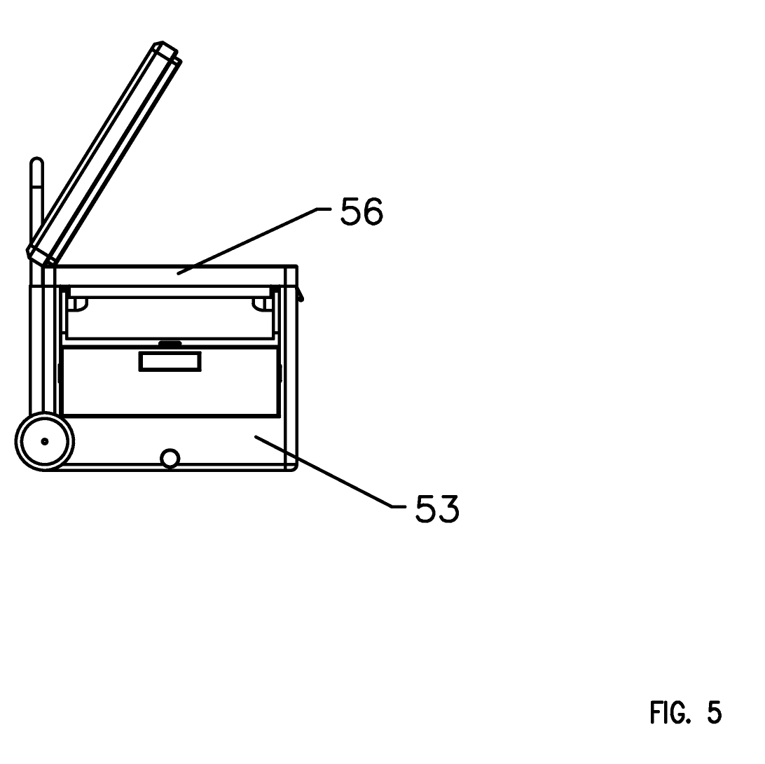

FIG. 6 depicts a front elevation view of the ice chest of FIG. 1.

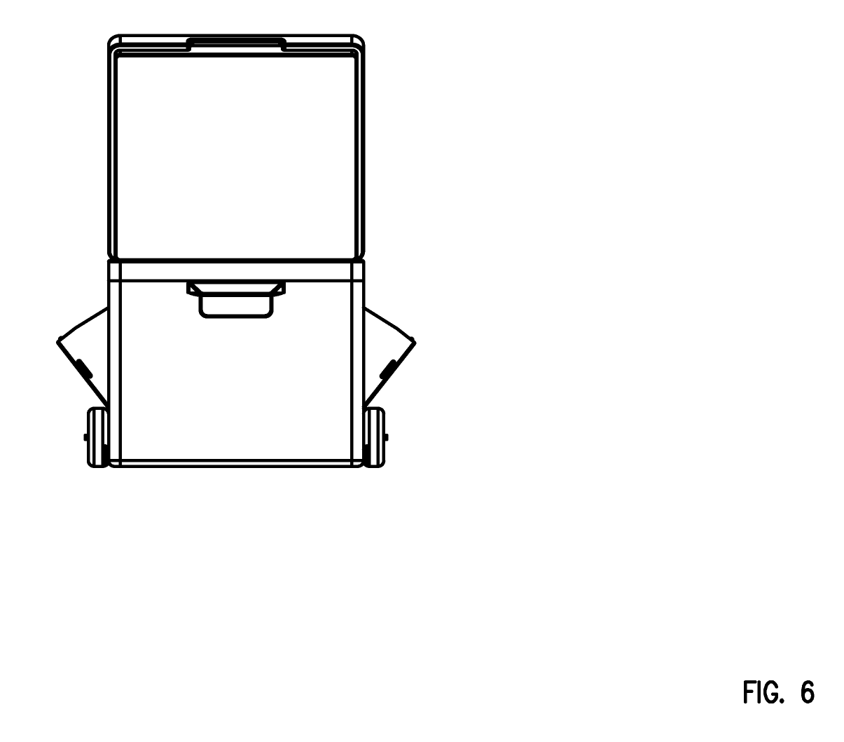

FIG. 7 depicts a rear elevation view of the ice chest of FIG. 1.

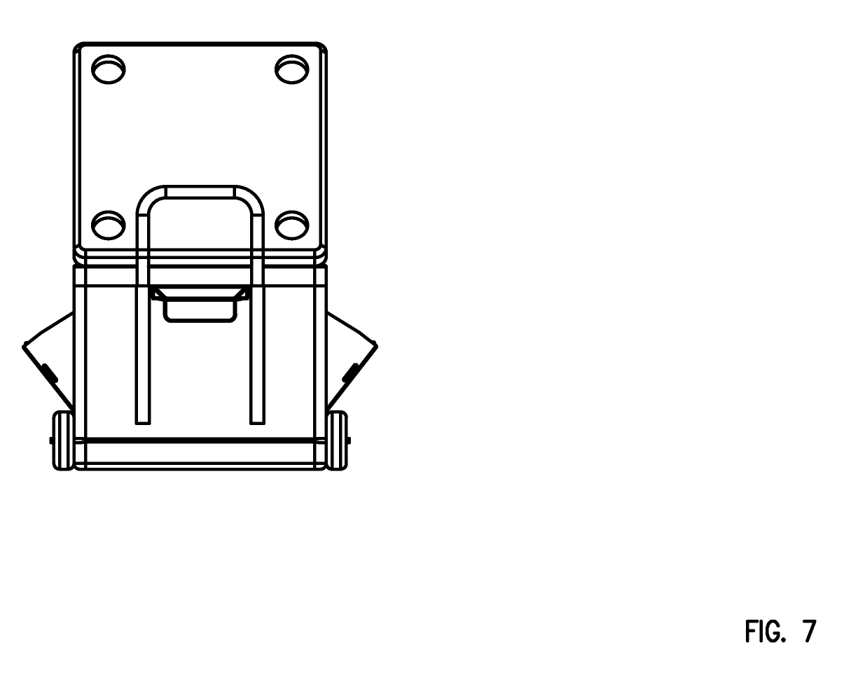

FIG. 8 depicts an exploded view of the ice chest of FIG. 1.

FIG. 9 depicts a close-up view of the material encircled in FIG. 1.

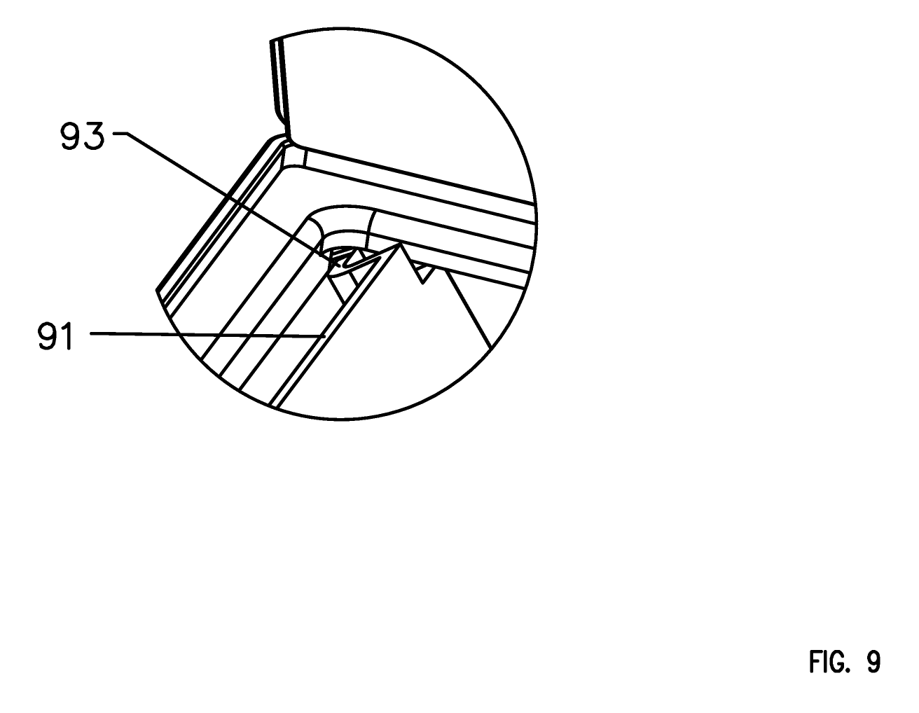

FIG. 10 depicts a perspective view of the bin of FIG. 1, removed from the housing.

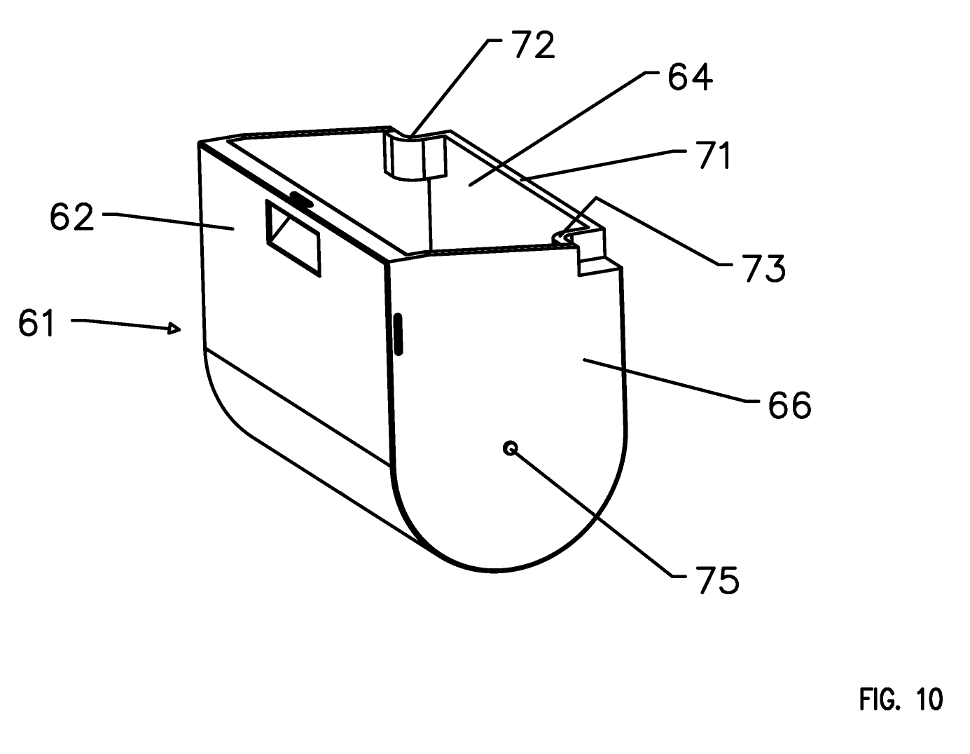

FIG. 11 depicts a top elevation view of the bin of FIG. 10.

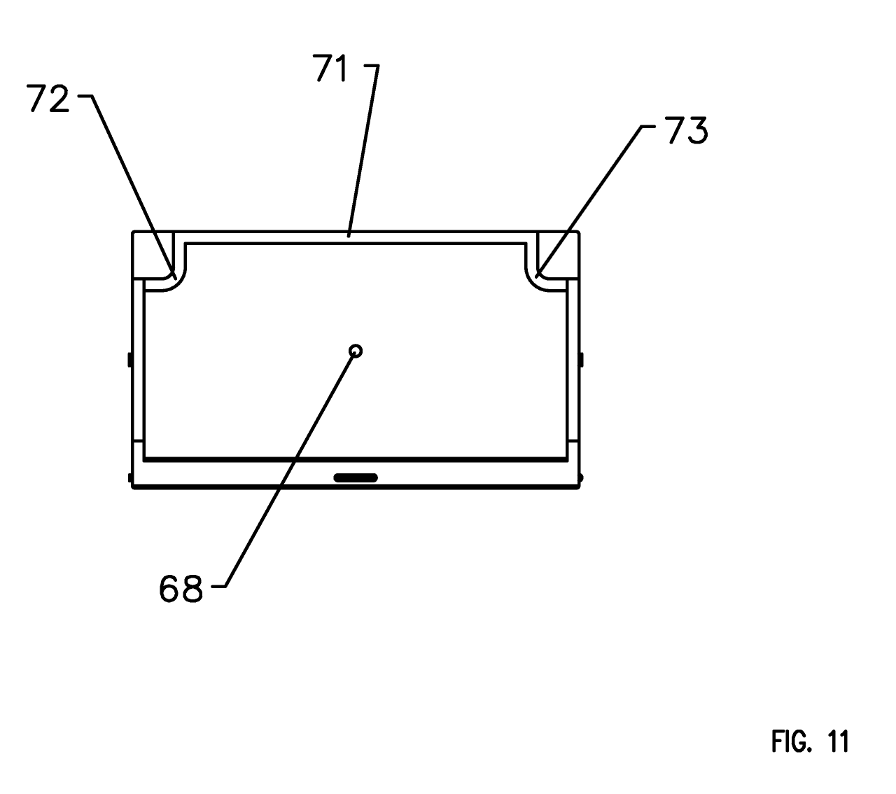

FIG. 12 depicts a side elevation view of the bin of FIG. 10, the opposite side view being a mirror image.

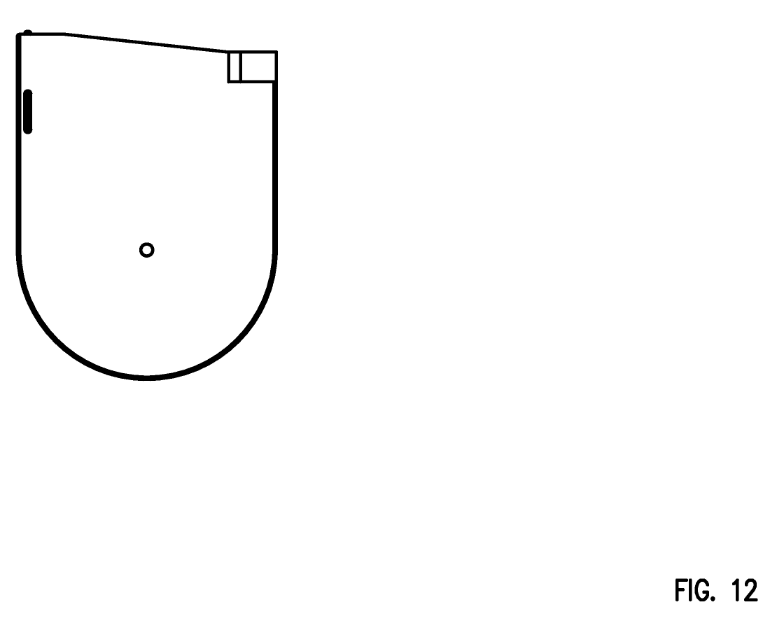

FIG. 13 depicts a front elevation view of the bin of FIG. 10.

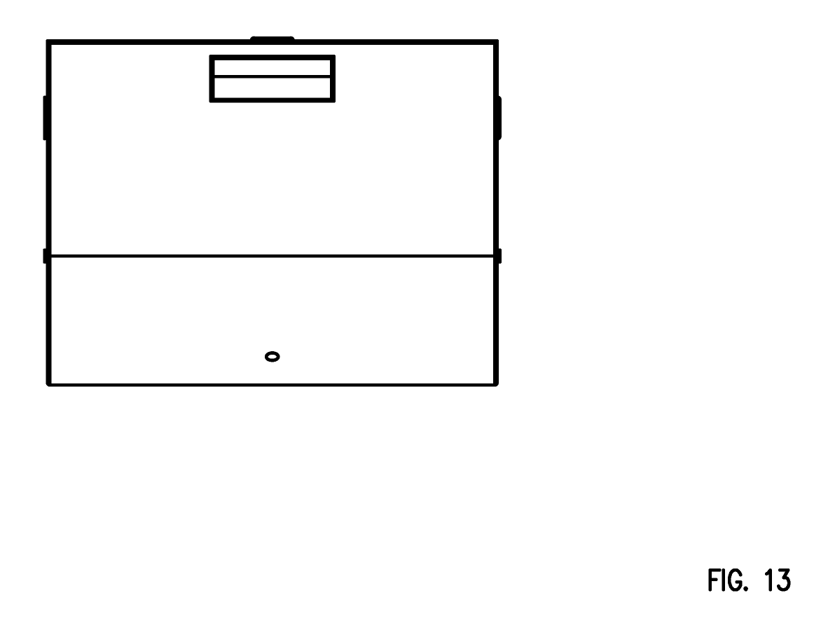

FIG. 14 depicts a rear elevation view of the bin of FIG. 10.

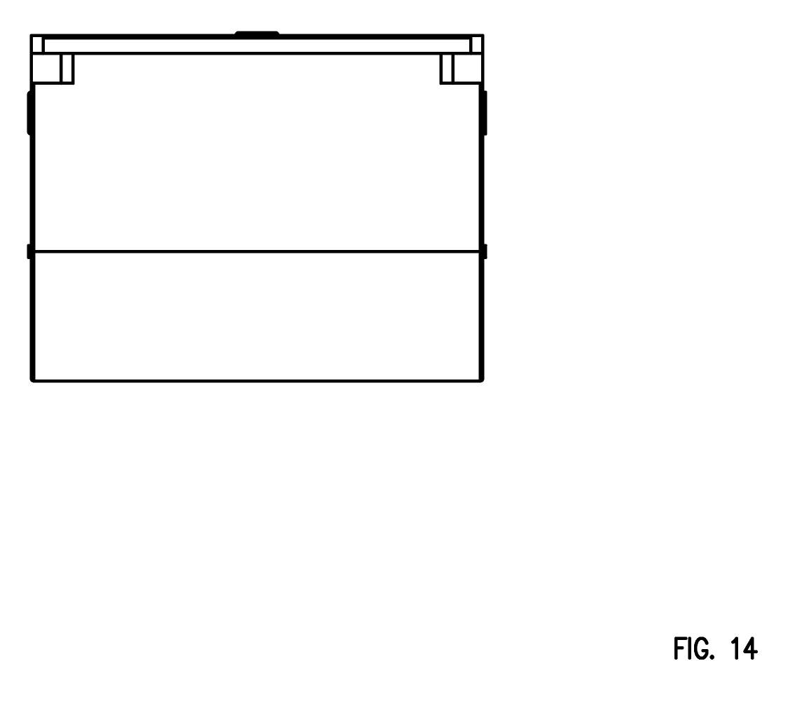

FIG. 15 depicts the same view as FIG. 1, but with the lid and both bins closed.

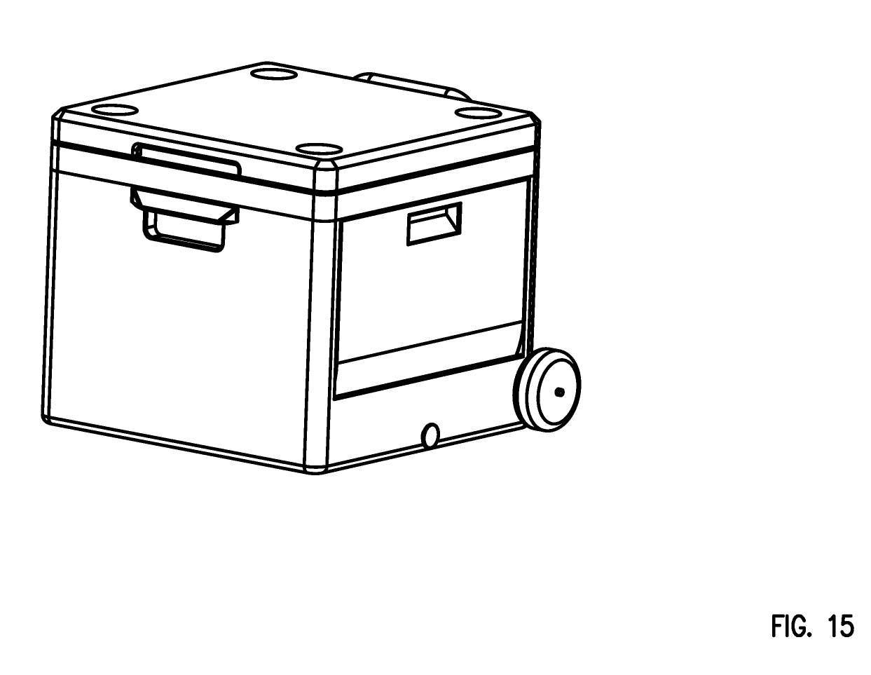

FIG. 16 depicts a top elevation view of the ice chest of FIG. 15.

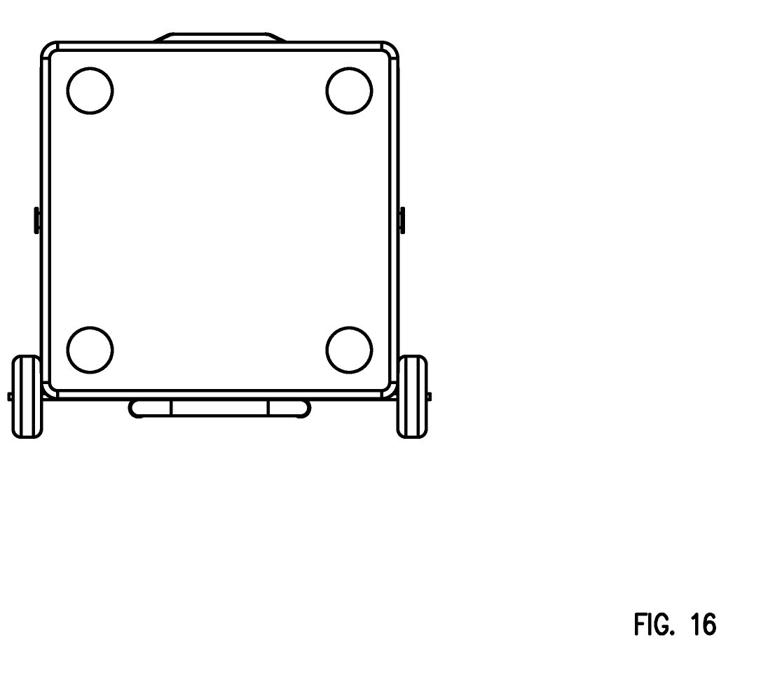

FIG. 17 depicts a left side elevation view of the ice chest of FIG. 15.

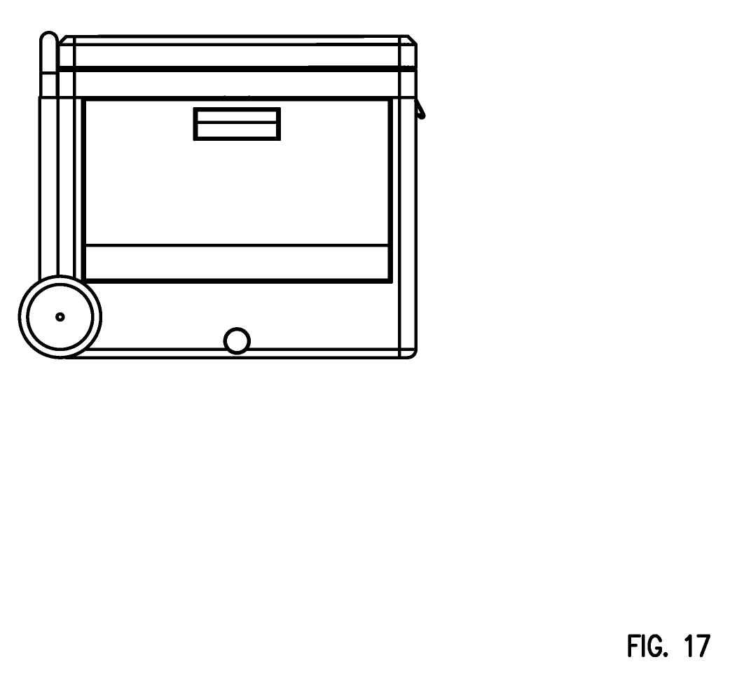

FIG. 18 depicts a front elevation view of the ice chest of FIG. 15.

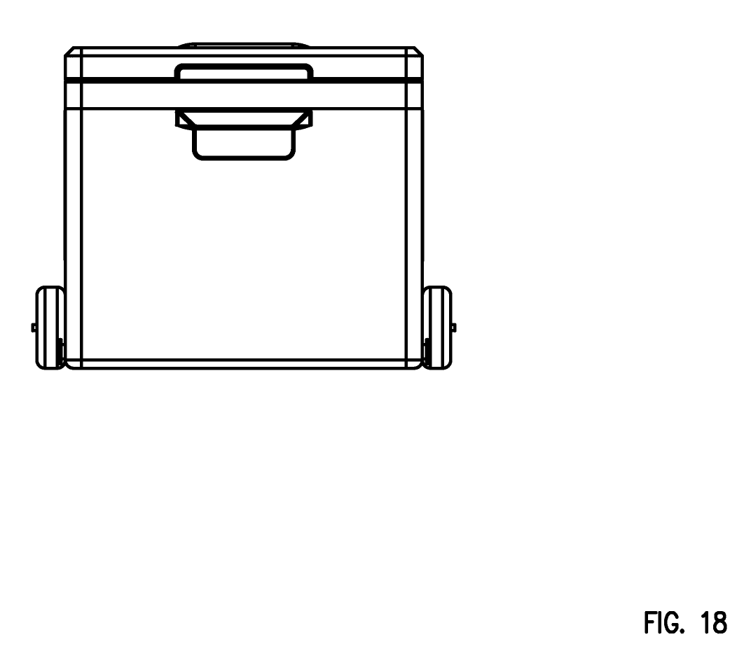

The broken lines are for illustrative purposes only, and do not form part of the claimed invention.

### DETAILED DESCRIPTION OF THE INVENTION

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprising” or “having” or “including, or a derivative of any of those terms, when used in this specification, specify the presence of stated features, regions, integers, steps, operations, elements, and/or components, but do not preclude the presence or addition of one or more other features, regions, integers, steps, operations, elements, components, and/or groups thereof.

For the sake of simplicity and to give the claims of this patent application the broadest interpretation and construction possible, the conjunctive “and” may also be taken to include the disjunctive “or,” and vice versa, whenever necessary to give the claims the broadest interpretation and construction possible. Likewise, when the plural form is used, it may be taken to include the singular form, and vice versa.

It will be understood that, although the terms first, second, third, etc. may be used herein to describe various elements, these elements should not be limited by these terms. These terms are only used to distinguish one element from another element. The same goes for the use of terms such as forward and rearward, and similar relative or comparative terms.

The disclosure herein is not limited by construction materials to the extent that such materials satisfy the structural and/or functional requirements. For example, any material may be used so long as it satisfies the structural and functional requirements for which it is being used. The container may be made of any material providing the necessary insulated form necessary for pivot-out access while retaining cryogenic properties.

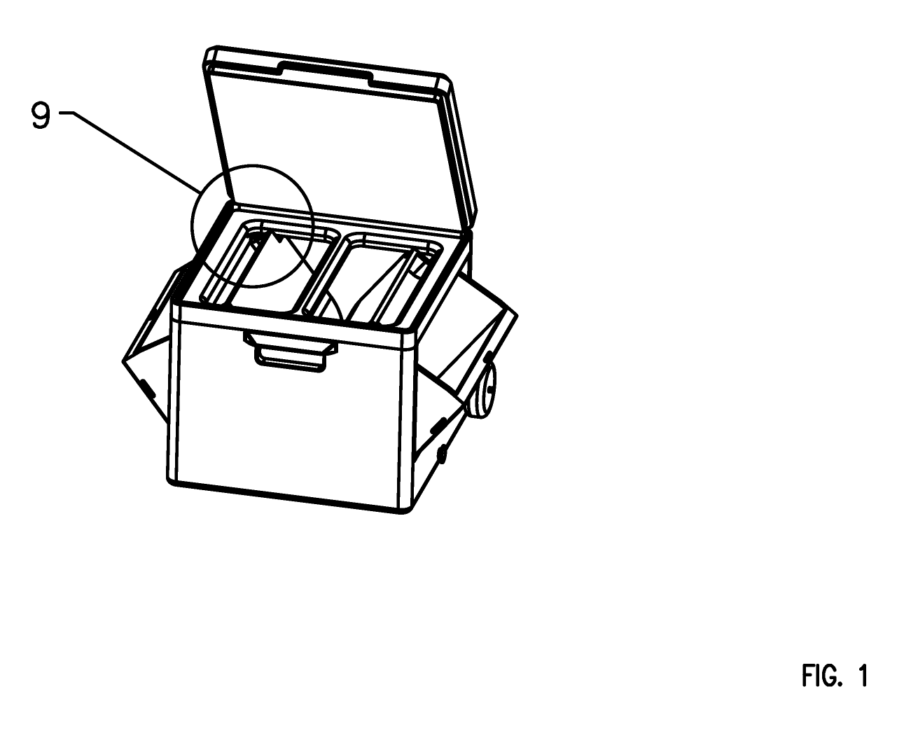

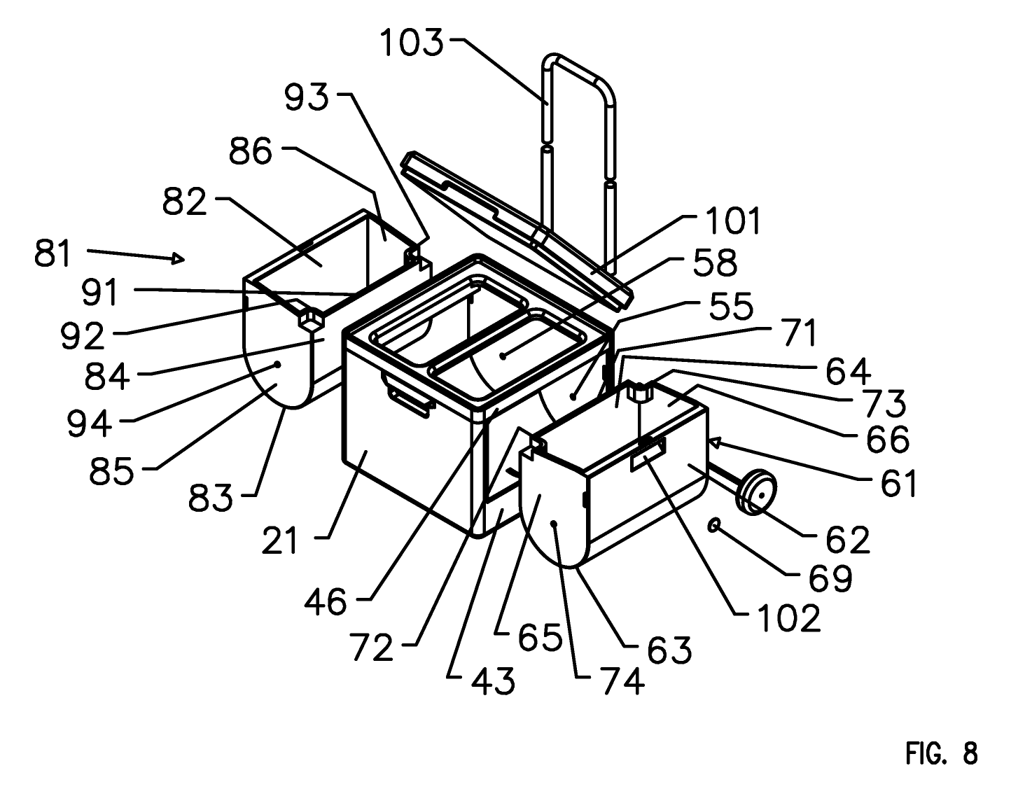

In the form of invention illustrated in FIG. 8, there is illustrated a cryogenic container that is essentially a box having a bottom panel or floor, a front panel, a rear panel, and a first side panel functioning as a bin-carriage rack. Although the container may only have a single bin-carriage rack, the representative sample depicted in FIG. 1 also has a second side panel functioning as a bin-carriage rack. All sides of the box form a first interior volume. All panels are connected to the perimeter of the bottom panel, and to adjacent panels to form an enclosure. All vertical panels may have an upper edge supporting a lid, which may be detachable or hingedly attached.

More particularly, the invention disclosed herein comprises a cryogenic storage container that includes a housing having a floor extending upwardly and merging into at least one upstanding enclosure frame defining an essentially vertical access aperture and having an upper edge supporting a lid. Also included is at least one top-accessible interior bin carried therein and having an outer binwall essentially coplanar within the aperture when closed; the interior of the bin is accessible by movement of said outer binwall through the aperture without moving the lid.

The floor may extend upwardly and merge into the enclosure frame, which may include a front panel, a rear panel, a second side panel, and a first side bin-carriage rack defining the aperture. Preferably there is a means of releasably retaining the outer binwall(s) within the aperture.

The enclosure frame may further include a bin-carrying means cooperating with the bin for pivoting the bin outwardly to an accessible position. The bin may further include an interiorly concave bottom extending upwardly and merging into the outer binwall and an opposite inner binwall, connected by a forward side binwall and a rearward side binwall. The first side bin-carriage rack may include an upper span portion defining the upper boundary of the aperture and a lower span portion defining the lower boundary of the aperture. The inner binwall may have an uppermost median edge of lesser height than the outer binwall, a forward corner notch supporting an upstanding forward transition edge lower than the outer binwall and a rearward corner notch supporting an upstanding rearward transition edge lower than the outer binwall. The outward pivoting of the bin may be stopped by the uppermost median edge contacting the upper span.

The first side bin-carriage rack may further include a forward side portion defining the forward boundary of the aperture, and a rearward side portion defining the rearward boundary of the aperture. Alternatively, the forward boundary of the aperture may be defined by the margin or edge of the front panel, and the rearward boundary of the aperture may be defined by the margin or edge of the rear panel. The outer binwall may have a forward margin with a forward edge, and a rearward margin with a rearward edge closely adjacent to the respective edge of the bin-carriage rack. The means of releasably retaining the outer binwall coplanar with (or in) the aperture may include a rearward boundary detent snugly accepting a complimentary rearward edge protuberance, and/or a forward boundary detent snugly accepting a complimentary forward edge protuberance. Alternatively, the means of releasably retaining the outer binwall coplanar with (or in) the aperture may include a rearward boundary protuberance snugly accepted within a complimentary rearward edge detent, and/or a forward boundary protuberance snugly accepted within a complimentary forward edge detent. Any other means of releasably retaining the outer binwall coplanar with (or in) the aperture may be used as well.

The cooperation between the bin-carrying means and the bin may include a pair of aligned bores in the front panel and rear panel above the lower span, and a pair of pivot-pins, each on an opposite side binwall and acceptable within a respective bore when the outer binwall is coplanar within the aperture before commencing any outward pivoting. Alternatively and equivalently, the pivot pins may be in the side binwalls of one or more bin, aligned with respective bores within the front and rear panels.

The forward side binwall may extend from the forward edge of the inner binwall, and have a height increasing until merging with the forward margin of the outer binwall; and the rearward side binwall may extend from the rearward edge of the inner binwall, and have a height increasing until merging with the rearward margin of the outer binwall. The outer binwall may have a beveled-in strip extending upwardly commencing adjacent the lower span; this will reduce or prevent any binding contact between the outer binwall and the lower span, when a bin is pivoted outward.

In another embodiment of the invention, the second side panel may include a second side bin-carriage rack that is a mirror image of the first side bin-carriage rack. The first bin may have a forward side binwall and rearward side binwall slightly less than half the length between the inner binwall and outer binwall. The second bin may be a mirror image of the half-length first bin.

One preferred embodiment comprises a cryogenic storage container having a lid (101) and at least two interior top-accessible bins that are outwardly pivotable for accessing without moving the lid. The container includes a housing including a floor (11) extending upwardly at the periphery and merging into a front panel (21) and a rear panel (31), and merging into:

(1) a first side bin-carriage rack defining a first access aperture defined by a first lower span portion, a first forward side portion further defining a first forward bore higher than the first lower span, an upper span portion and a rearward side portion further defining a first rearward bore aligned with the first forward bore; and

(2) a second side bin-carriage rack defining a second access aperture defined by a second lower span portion, a second forward side portion further defining a second forward bore higher than the second lower span, an upper span portion, and a rearward side portion further defining a second rearward bore aligned with the second forward bore.

The container also includes a first top-accessible interior bin (61) carried within the housing and having a first outer binwall essentially coplanar within the first aperture. The first bin may include an interiorly concave bottom extending upwardly and merging into the first outer binwall and an opposite first inner binwall, connected by a first forward side binwall and a first rearward side binwall. The first outer binwall may have a first forward margin with a first forward edge, a first upper margin with a first upper edge, a first rearward margin with a first rearward edge and a first beveled-in strip extending upwardly commencing adjacent the first lower span. The first inner binwall may have a first uppermost median edge of lesser height than the first outer binwall, a first forward corner notch supporting an upstanding forward transition edge lower than the first outer binwall and a first rearward corner notch supporting an upstanding rearward transition edge lower than the first outer binwall. The first forward side binwall may extend from the first forward edge of the first inner binwall and have a height increasing until merging with the forward margin of the first outer binwall, and further include a first forward pivot pin aligned with and received within the first forward bore when the first outer binwall is coplanar within the first aperture. The first rearward side binwall may extend from the first rearward edge of the first inner binwall and have a height increasing until merging with the first rearward margin of the first outer binwall, and further include a first rearward pivot pin aligned with and received within the first rearward bore when the first outer binwall is coplanar within the first aperture.

The container also includes a second top-accessible interior bin (82) carried within the housing, essentially a mirror image of the first interior bin. It may have a second outer binwall essentially coplanar within the second aperture, The second bin may also include an interiorly concave bottom extending upwardly and merging into the second outer binwall and an opposite second inner binwall, connected by a second forward side binwall and a second rearward side binwall. The second outer binwall may have a second forward margin with a second forward edge, a second upper margin with a second upper edge, a second rearward margin with a second rearward edge and a second beveled-in strip extending upwardly commencing adjacent the second lower span. The second inner binwall may have a second uppermost median edge of lesser height than the second outer binwall, a second forward corner notch supporting an upstanding forward transition edge lower than the second outer binwall and a second rearward corner notch supporting an upstanding rearward transition edge lower than the second outer binwall. The second forward side binwall may extend from the second forward edge of the second inner binwall and have a height increasing until merging with the second forward margin of the second outer binwall, and further include a second forward pivot pin aligned with and received within the second forward bore when the second outer binwall is coplanar within the second aperture. The second rearward side binwall may extend from the second rearward edge of the second inner binwall and have a height increasing until merging with the second rearward margin of the second outer binwall, and further include a second rearward pivot pin aligned with and received within the second rearward bore when the second outer binwall is coplanar within the second aperture.

Each of the front panel, rear panel, first side bin-carriage rack and/or second side bin-carriage rack may further include a respective uppermost edge cooperating to support a lid.

The first outer binwall may further include a plurality of detents positioned along the first outer binwall edges, each detent snugly accepting a complimentary protuberance outstanding from an adjacent first side bin-carriage rack. The second outer binwall may further include a plurality of detents positioned along the second outer binwall edges, each detent snugly accepting a complimentary protuberance outstanding from an adjacent second side bin-carriage rack. The detents and protuberances cooperate to releasably lock the respective outer binwalls coplanar within the respective access apertures. It does not matter whether any of the detents and/or protuberances are part of an outer binwall or side bin-carriage rack.

Also included may be a plurality of handle means for grasping the housing, or a lid or bin thereof, including members of a group consisting of an indent forming a ledge, an outstanding anchored handle member and a pivotably mounted handle member, and combinations thereof. Preferably, each of the bins further includes an indent forming a ledge for grasping to pivot the bin, each of front panel and rear panel further includes an indent forming a ledge for grasping to move the container; and the lid is hingedly attached to an upper edge of the housing, and further includes an indent forming a ledge for grasping to open the lid. Also included is a plurality of wheels affixed to the container facilitating rolling thereof. The floor further includes an interiorly concave inner surface essentially matching the concave bin bottom, the bin including a closeable drainage hole, and the lower span of the housing including a drainage channel.

One alternative embodiment comprises a cryogenic storage container having a lid (101) and at least two interior top-accessible interior bins that are outwardly pivotable for accessing without moving the lid. The container comprises a housing including a floor (11) extending upwardly at the periphery and merging into:

(1) a front panel (21) having a first side margin and a first side interior bore (45), a second side margin and a second side interior bore (48);

(2) a rear panel (31) having a first side margin and first side interior bore (55) aligned with the front panel first side bore, and a second side margin and a second side interior bore (58) aligned with the front panel second side bore;

(3) a first side bin-carriage rack (41) defining a first access aperture defined by a first lower span portion (43) and a first upper span portion (46) and by the first side margins of the front and rear panels; and

(4) a second side bin-carriage rack (51) defining a second access aperture defined by a second lower span portion (53) and a second upper span portion (56) and by the second side margins of the front and rear panels.

The container further comprises a first top-accessible interior bin (61) carried within the housing and having a first outer binwall (62) essentially coplanar within the first aperture. The first bin may include an interiorly concave bottom (63) extending upwardly and merging into the first outer binwall and an opposite first inner binwall (64), connected by a first forward side binwall (65) and a first rearward side binwall (66). The first outer binwall may have a first forward margin, a first rearward margin and a first beveled-in strip (70) extending upwardly commencing adjacent and above the first lower span. The beveled-in strip reduces or eliminates contact or binding between the bin-carriage rack's lower span and the outer binwall.

The first inner binwall may have a first uppermost median edge (71) of lesser height than the first outer binwall, a first forward corner notch supporting an upstanding forward transition edge (72) lower than the first outer binwall and a first rearward corner notch supporting an upstanding rearward transition edge (73) lower than the first outer binwall. The first forward side binwall may have a height increasing until merging with the first forward margin of the first outer binwall, and further comprising a first forward side pivot pin (74) aligned with and received within the front panel first side bore when the first outer binwall is coplanar within the first aperture. The first rearward side binwall may have a height increasing until merging with the first rearward margin of the first outer binwall, and further comprising a first rearward side pivot pin (75) aligned with and received within the rear panel first side bore when the first outer binwall is coplanar within the first aperture.

The container may further comprise a second top-accessible interior bin (81) carried within the housing, which may have a second outer binwall (82) essentially coplanar within the second aperture. The second bin may comprise an interiorly concave bottom (83) extending upwardly and merging into the second outer binwall and an opposite second inner binwall (84), connected by a second forward side binwall (85) and a second rearward side binwall (86). The second outer binwall may have a second forward margin, a second rearward margin and a second beveled-in strip (90) extending upwardly commencing adjacent the second lower span. The second inner binwall may have a second uppermost median edge (91) of lesser height than the second outer binwall, a second forward corner notch supporting an upstanding forward transition edge (92) lower than the second outer binwall and a second rearward corner notch supporting an upstanding rearward transition edge (93) lower than the second outer binwall. The second forward side binwall may have a height increasing until merging with the second forward margin of the second outer binwall, and further comprising a second side forward pivot pin (94) aligned with and received within the front panel second side bore when the second outer binwall is coplanar within the second aperture. The second rearward side binwall may have a height increasing until merging with the second rearward margin of the second outer binwall, and further comprising a second rearward side pivot pin (95) aligned with and received within the rear panel second side bore when the second outer binwall is coplanar within the second aperture.

The front panel and rear panel first side margins may further comprise a plurality of interior detents, whereas the first forward and rearward side binwalls may further comprise a respective forward side margin and include a plurality of protuberances aligned therein with the detents, each detent snugly accepting a respective aligned protuberance. The front panel and rear panel second side margins may further comprise a plurality of interior detents, whereas the second forward and rearward side binwalls may further comprise a respective forward side margin and include a plurality of protuberances aligned therein with the detents, each detent snugly accepting a respective aligned protuberance, the detents and protuberances cooperating to releasably retain the respective outer binwalls coplanar within the respective access apertures.

The concave bottom of the bin may also include a closeable drainage hole (68), while the lower span may include a drainage channel. Drainage may be stopped by an internal or external closure member such as a cap (69).

The container may further include one or more handle means for grasping the container, or a lid or bin thereof. Examples of such means include members of a group consisting of an indent forming a ledge (102), an outstanding anchored handle member and a pivotably mounted handle member, and combinations thereof. The container may further include a plurality of wheels affixed to the container, facilitating rolling thereof. A telescopic guidance handle (103) may also be affixed to the container.

The lid may be detachable, or hingedly attached to the container.

Besides the apparatus described herein, the invention also includes the method of using that apparatus. To fill the ice chest with ice and/or beverages or other items for cooling, the user may lift the lid while the side bin(s) are closed, then deposit the desired items into a top-accessible bin. Alternatively, the user may swivel each side bin outward from its closed position, then deposit the desired items.

I claim:

1. A cryogenic storage container comprising:
(a) a housing having a floor extending upwardly and merging into at least one upstanding enclosure frame defining an essentially vertical access aperture and having an upper edge supporting a lid; and
(b) at least one top-accessible interior bin carried therein and having an outer binwall essentially coplanar within said aperture, the interior of said bin accessible by movement of said outer binwall through said aperture without moving said lid.

2. The cryogenic container of claim 2 defining an enclosure volume, said floor extending upwardly and merging into said enclosure frame comprising a front panel, a rear panel, a second side panel, a first side bin-carriage rack defining said aperture, and a means of releasably retaining said outer binwall within said aperture;
(a) said enclosure frame further comprising a bin-carrying means cooperating with said bin for pivoting said bin outwardly to an accessible position; and
(b) said bin further comprising an interiorly concave bottom extending upwardly and merging into said outer binwall and an opposite inner binwall, connected by a forward side binwall and a rearward side binwall.

3. The cryogenic container of claim 2, wherein:
(a) said first side bin-carriage rack includes an upper span portion defining an upper boundary of said aperture and a lower span portion defining a lower boundary of said aperture;
(b) said inner binwall having an uppermost median edge of lesser height than said outer binwall, a forward corner notch supporting an upstanding forward transition edge lower than said outer binwall and a rearward corner notch supporting an upstanding rearward transition edge lower than said outer binwall; and
(c) said outward pivoting stopped by said uppermost median edge contacting said upper span.

4. The cryogenic container of claim 2, said front panel defining the forward boundary of said aperture and a rearward side portion defining the rearward boundary of said aperture, said outer binwall having a forward margin with a forward edge and a rearward margin with a rearward edge, said means of releasably retaining said outer binwall coplanar into said aperture comprising a rearward boundary detent snugly accepting a complimentary rearward edge protuberance and a forward boundary detent snugly accepting a complimentary forward edge protuberance.

5. The cryogenic container of claim 4, said front panel including an interior bore at a level higher than said lower span and said rear panel including an interior bore aligned opposite that of the front panel, said forward side binwall including a pivot-pin snugly acceptable within the bore of the front panel when said outer binwall is coplanar within said aperture before commencing any outward pivoting, and said rearward side binwall including a pivot-pin snugly acceptable within the bore of the rear panel when said outer binwall is coplanar within said aperture before commencing any outward pivoting.

6. The cryogenic container of claim 5, said forward side binwall having a height increasing until merging with said forward margin of said outer binwall, and said rearward side binwall having a height increasing until merging with said rearward margin of said outer binwall.

7. The cryogenic container of claim 3, said outer binwall having a beveled-in strip extending upwardly commencing adjacent and above said lower span.

8. The cryogenic container of claim 2, said concave bottom of said bin including a closeable drainage hole.

9. The cryogenic container of claim 8, said lower span including a drainage channel.

10. The cryogenic container of claim 1 further comprising a handle means for grasping said container, or a lid or bin thereof, including members of a group consisting of an indent forming a ledge, an outstanding anchored handle member and a pivotably mounted handle member, and combinations thereof.

11. The cryogenic container of claim 1, further comprising a plurality of wheels affixed to said container facilitating rolling thereof.

12. The cryogenic container of claim 1, further comprising a telescopic guidance handle affixed to said container.

13. The cryogenic container of claim 10, said lid hingedly attached to said container.

14. The cryogenic container of claim 2, said second side panel comprising a second side bin-carriage rack comprising a mirror image of said first side bin-carriage rack, said bin having a forward side binwall and rearward side binwall slightly less than half the horizontal length of said front panel and said rear panel, said container further comprising a second bin comprising a mirror image of said first bin and likewise pivotally carried by said second side bin-carriage rack.

15. A cryogenic storage container having a lid and at least two interior top-accessible interior bins that are outwardly pivotable for accessing without moving said lid, said container comprising:
(a) a housing defining an enclosure volume comprising a floor extending upwardly at the periphery and merging into
(1) a front panel having a first side margin and a first side interior bore, a second side margin and a second side interior bore, and
(2) a rear panel having a first side margin and first side interior bore aligned with said front panel first side bore, and a second side margin and a second side interior bore aligned with said front panel second side bore, and
(3) a first side bin-carriage rack defining a first access aperture defined by a first lower span portion and a first upper span portion and by said first side margins of said front and rear panels, and
(4) a second side bin-carriage rack defining a second access aperture defined by a second lower span portion and a second upper span portion and by said second side margins of said front and rear panels; said container further comprising:
(b) a first top-accessible interior bin carried within said housing and having a first outer binwall essentially coplanar within said first aperture, said first bin comprising an interiorly concave bottom extending upwardly and merging into said first outer binwall and an opposite first inner binwall, connected by a first forward side binwall and a first rearward side binwall,
(1) said first outer binwall having a first forward margin, a first rearward margin and a first beveled-in strip extending upwardly commencing adjacent and above said first lower span,
(2) said first inner binwall having a first uppermost median edge of lesser height than said first outer binwall, a first forward corner notch supporting an upstanding forward transition edge lower than said first outer binwall and a first rearward corner notch supporting an upstanding rearward transition edge lower than said first outer binwall,
(3) said first forward side binwall having a height increasing until merging with said first forward margin of said first outer binwall, and further comprising a first forward side pivot pin aligned with and received within said front panel first side bore when said first outer binwall is coplanar within said first aperture,
(4) said first rearward side binwall having a height increasing until merging with said first rearward margin of said first outer binwall, and further comprising a first rearward side pivot pin aligned with and received within said rear panel first side bore when said first outer binwall is coplanar within said first aperture;
(c) a second top-accessible interior bin carried within said housing and having a second outer binwall essentially coplanar within said second aperture, said second bin comprising an interiorly concave bottom extending upwardly and merging into said second outer binwall and an opposite second inner binwall, connected by a second forward side binwall and a second rearward side binwall,
(1) said second outer binwall having a second forward margin, a second rearward margin and a second beveled-in strip extending upwardly commencing adjacent said second lower span,
(2) said second inner binwall having a second uppermost median edge of lesser height than said second outer binwall, a second forward corner notch supporting an upstanding forward transition edge lower than said second outer binwall and a second rearward corner notch supporting an upstanding rearward transition edge lower than said second outer binwall,
(3) said second forward side binwall having a height increasing until merging with said second forward margin of said second outer binwall, and further comprising a second side forward pivot pin aligned with and received within said front panel second side bore when said second outer binwall is coplanar within said second aperture,
(4) said second rearward side binwall having a height increasing until merging with said second rearward margin of said second outer binwall, and further comprising a second rearward side pivot pin aligned with and received within said rear panel second side bore when said second outer binwall is coplanar within said second aperture; and
(d) said container further comprising a lid supported atop said housing.

16. The cryogenic container of claim 15, said front panel and rear panel first side margins further comprising a plurality of interior protuberances, said first forward and rearward side binwalls further comprising a respective forward side margin and further comprising a plurality of detents aligned therein with said protuberances, each detent snugly accepting a respective aligned protuberance, said front panel and rear panel second side margins further comprising a plurality of interior protuberances, said second forward and rearward side binwalls further comprising a respective forward side margin and further comprising a plurality of detents aligned therein with said protuberances, each detent snugly accepting a respective aligned protuberance, said detents and protuberances cooperating to releasably retain said respective outer binwalls coplanar within said respective access apertures.

17. A cryogenic container of claim 15, further comprising a plurality of handle means for grasping said housing, or a lid or bin thereof, including members of a group consisting of an indent forming a ledge, an outstanding anchored handle member and a pivotably mounted handle member, and combinations thereof.

18. A cryogenic container of claim 15, each of said bins further comprising an indent forming a ledge for grasping to pivot said bin, each of front panel and rear panel further comprising an indent forming a ledge for grasping to move said container, and said lid hingedly attached to an upper edge of said housing and further comprising an indent forming a ledge for grasping to open said lid.

19. A cryogenic container of claim 17, further comprising a plurality of wheels affixed to said container facilitating rolling thereof.

20. A cryogenic container of claim 15, said floor further comprising an interiorly concave inner surface essentially matching said concave bin bottom, said bin including a closeable drainage hole, and said lower span of said housing including a drainage channel.
